(19) United States
(12) Patent Application Publication
(10) Pub. No.: US 2020/0158850 A1
(43) Pub. Date: May 21, 2020

(54) APPARATUS AND METHOD FOR LEARNING SCALE FACTOR OF VEHICLE SPEED SENSOR

(71) Applicant: DENSO CORPORATION, Kariya-city (JP)

(72) Inventors: Kazuma ISHIGAKI, Kariya-city (JP); Kentaro SHIOTA, Kariya-city (JP); Shinya TAGUCHI, Kariya-city (JP); Naoki NITANDA, Kariya-city (JP)

(21) Appl. No.: 16/557,034

(22) Filed: Aug. 30, 2019

(30) Foreign Application Priority Data
Aug. 31, 2018 (JP) 2018-163072

(51) Int. Cl. G01S 13/60; G07C 5/02; G01P 3/38

(52) U.S. Cl. CPC G01S 13/60; G07C 5/0841; G01P 3/38; G07C 5/02

(57) ABSTRACT

In an apparatus for learning a scale factor used to calculate a true value of a speed of a vehicle from a detected speed that is a sensor reading from a vehicle speed sensor, a sensor reading acquirer acquires the detected speed of the vehicle from the vehicle speed sensor. A relative speed detector detects a relative speed of the vehicle to a stationary object based on a result of detection by an object detector that detects an object around the vehicle. A scale factor calculator calculates the scale factor based on the relative speed and the detected speed.

### CROSS-REFERENCE TO RELATED APPLICATION

This application is based on and claims the benefit of priority from earlier Japanese Patent Application No. 2018-163072 filed on Aug. 31, 2018, the description of which is incorporated herein by reference.

### BACKGROUND

### Technical Field

This disclosure relates to a technique for learning a scale factor of a vehicle speed sensor.

### Related Art

A system is known that records location information including information about locations of landmarks using images captured by a camera mounted to a vehicle, uploads the location information to a server or the like to generate a sparse map, and downloads the sparse map during traveling of the vehicle to determine a location of the own vehicle.

### BRIEF DESCRIPTION OF THE DRAWINGS

In the accompanying drawings:

FIG. 1 is schematic diagram of a map system according to a first embodiment;

FIG. 2 is a flowchart of processing performed by a controller according to the first embodiment;

FIG. 3 is schematic diagram of a map system according to a second embodiment;

FIG. 4 is schematic diagram of a map system according to a third embodiment;

FIG. 5 is a flowchart of processing performed by a controller according to the third embodiment;

FIG. 6 is schematic diagram of a map system according to a fourth embodiment; and

FIG. 7 is a flowchart of processing performed by a controller according to the fourth embodiment.

### DESCRIPTION OF SPECIFIC EMBODIMENT

In the known system, as disclosed in WO2016130719, a Structure from Motion (SfM) technique is used to generate, on a vehicle side, probe data that is data to be uploaded to the server. In the SfM technique, sensor readings acquired from a vehicle speed sensor are used to detect a vehicle speed. If a scale factor of the vehicle speed sensor deviates from what it should be, errors will occur in the SfM, which may reduce the accuracy of localization and map generation. The scale factor of the vehicle speed sensor is a factor used to calculate a true value of vehicle speed from the sensor readings.

In view of the foregoing, it is desired to have a technique for accurately learning the scale factor of the vehicle speed sensor.

Hereinafter, exemplary embodiments of the present disclosure will be described in detail with reference to the accompanying drawings, in which like reference numerals refer to like or similar elements regardless of reference numerals and duplicated description thereof will be omitted.

First Embodiment

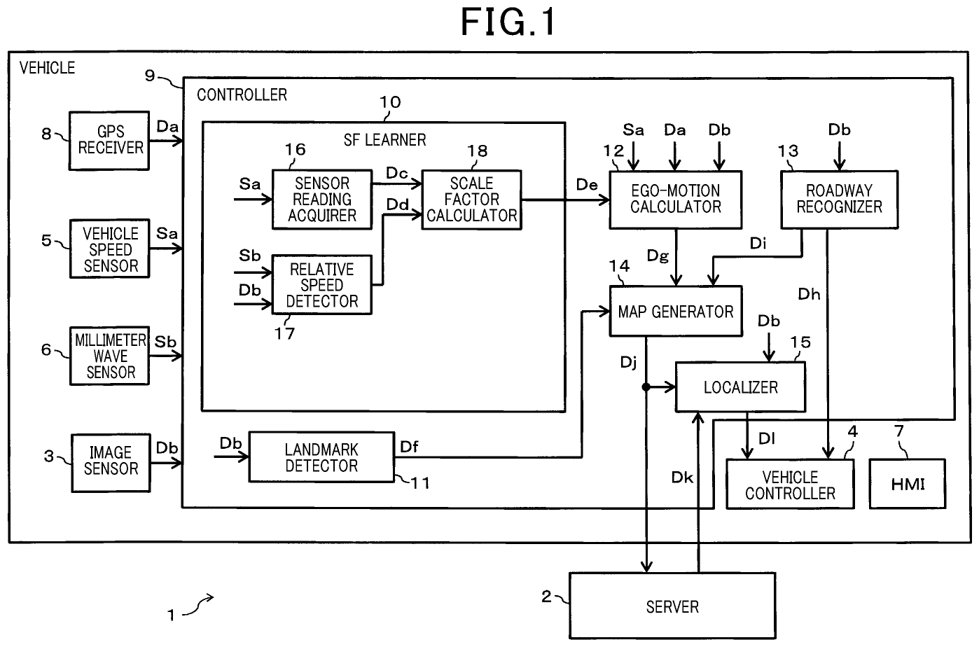

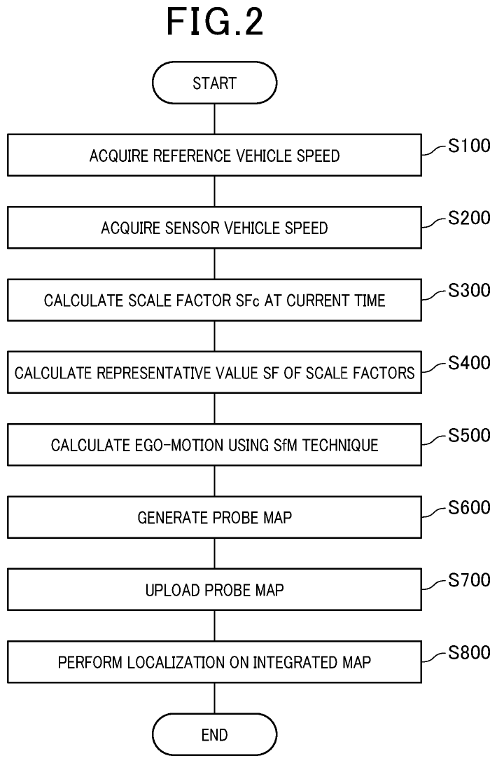

A first embodiment of the present disclosure will now be described with reference to FIGS. 1 and 2.

A map system 1 shown in FIG. 1 is a map system for autonomous navigation. The map system 1 exerts the effect on more accurately determining a location of an own vehicle in addition to a conventional GPS function. The map system 1 includes, in broad terms, two functions: map utilization and map update. the vehicle carrying the map system 1 is hereinafter referred to as an own vehicle. The own vehicle refers to a vehicle carrying the map system 1 with its server excluded.

In map utilization, map information stored in a server 2 is downloaded to the own vehicle. The own vehicle determines a location of the own vehicle based on the downloaded map information and locations of landmarks, such as traffic signs included in images captured by an image sensor 3, such as a camera. In the following, the map information stored in the server 2 is hereinafter referred to as an integrated map. A vehicle controller 4 outputs commands to respective actuators for operating hardware mounted to the own vehicle based on the current location of the own vehicle, thereby implementing driving assistance. The actuators are devices used to hardware-control the own vehicle, such as brakes, a throttle, a steering system, and lamps.

In map update, information acquired from the image sensor 3 and other sensors (e.g., a vehicle speed sensor 5, a millimeter wave sensor 6 and the like) mounted to the own vehicle is uploaded to the server 2 as probe data, and the integrated map in the server 2 is sequentially updated. This enables accurately determining the location of the own vehicle based on the latest map information and thus implementing driving assistance, automated steering and the like.

In the map system 1, the human-machine interface (HMI) 7 is a user interface used to notify a user of various information or allow the user to signal specific operations to the own vehicle. The HMI 7 includes a display associated with a navigation device, a display contained in an instrument panel, a head-up display projected onto a windshield, a microphone, a speaker and the like. The HMI 7 of the map system 1 may include a mobile device, such as a smart phone, communicatively connected to the own vehicle.

The user can not only visually acquire information displayed on the HMI 7, but also acquire information by voice, warning sound, or vibration. The user can request the own vehicle to perform desired operations by touch operations on the display or voice. For example, when the user wants to receive advanced driving assistance services, such as automated steering, utilizing map information, the user enables the map utilization function via the HMI 7. For example, when the user taps a “map connection” button on the display, the map utilization function will be enabled and the map information will be downloaded.

In another example, the map utilization function may be enabled by providing a voice command. The map information upload for the map update may normally be performed while communication between the own vehicle and the server 2 is established or while the map utilization is enabled by tapping the “map connection” button or via another user interface (UI) that reflects a willingness of the user.

The map system 1 of the present embodiment includes the server 2, the image sensor 3, the vehicle controller 4, the vehicle speed sensor 5, the millimeter wave sensor 6, the HMI 7, the GPS receiver 8, and the controller 9. The server 2 includes a controller (not shown) and other components (not shown), where the controller performs various processing set forth above relating to the map update. The GPS receiver 8 outputs GPS information Da represented by signals received via a GPS antenna (not shown) to the controller 9 or the like. The vehicle speed sensor 5 is configured as a wheel speed sensor for detecting a wheel speed. The vehicle speed sensor 5 outputs a signal Sa that represents a detected vehicle speed to the controller 9 and other components.

The millimeter wave sensor 6 is mounted to the own vehicle. The millimeter wave sensor 6 includes a radar device that transmits radar waves in a forward and travel direction and receives reflected waves from objects located around the own vehicle. The millimeter wave sensor 6 serves as an object detector that detects objects around the own vehicle. The millimeter wave sensor 6 outputs a signal Sb representing a location and the like of each detected object to the controller 9 and other components.

The image sensor 3 is mounted to the own vehicle. The image sensor 3 is an imager that captures images of an environment around the own vehicle, more specifically, an environment within a predetermined range in the forward and travel direction of the own vehicle. Additionally or alternatively, the image sensor 3 may capture images of an environment in a backward or sideways direction of the own vehicle. Information about the environment acquired by the image sensor 3 may be stored in a memory (not shown) in the form of still images or moving images (hereinafter referred to as images). The controller 9 may be configured to read data Db from the memory to perform various processing based on the data Db.

The controller 9 is configured as a microcomputer including a central processing unit (CPU), a read-only memory (ROM), a random-access memory (RAM), and an input/output interface (I/O). The controller 9 includes, as functional blocks, a scale factor (SF) learner 10, a landmark detector 11, an ego-motion calculator 12, a roadway recognizer 13, a map generator 14, and a localizer 15. Functions of these blocks, as described later in detail, may be implemented by software, that is, by the CPU executing computer programs stored in a non-transitory, tangible storage medium such as a semiconductor memory. Functions of the controller 9 may be implemented by software only, hardware only, or a combination thereof. For example, when these functions are provided by an electronic circuit which is hardware, the electronic circuit can be provided by a digital circuit including many logic circuits, an analog circuit, or a combination thereof.

The SF learner 10, which serves as a scale factor learning apparatus for learning a scale factor of the vehicle speed sensor 5, includes a sensor reading acquirer 16, a relative speed detector 17, and a scale factor calculator 18. The computer programs to be executed by the microcomputer of the controller 9 includes a scale factor learning program for learning a scale factor of the vehicle speed sensor 5.

The scale factor of the vehicle speed sensor 5 is a ratio of a vehicle speed to be measured by the vehicle speed sensor 5 to a sensor reading from the vehicle speed sensor 5, that is, a ratio of an output change to an input change of the vehicle speed sensor 5. The scale factor SF of the vehicle speed sensor 5 can be expressed using the following equation (1):

SF=va/vb (1)

where va represents an actual vehicle speed, i.e., a true value of the vehicle speed, and vb represents a sensor reading from the vehicle speed sensor 5.

The SF learning unit 10 learns the scale factor SF of the vehicle speed sensor 5 based on the signal Sa from the vehicle speed sensor 5, the signal Sb from the millimeter wave sensor 6, and the data Db from the image sensor 3. The sensor reading acquirer 16 acquires a detected speed that is a sensor reading from the vehicle speed sensor 5 based on the signal Sa. In the following, the detected speed is also referred to as a sensor vehicle speed. The sensor reading acquirer 16 outputs data Dc representing the sensor vehicle speed to the scale factor calculator 18. Various processing performed by the sensor reading acquirer 16 corresponds to a sensor reading acquisition procedure.

The relative speed detector 17 detects a relative speed of the own vehicle to a stationary object based on the signal Sb representing a result of detection by the millimeter wave sensor 6. The relative speed detector 17 determines, by fusion of the result of detection by the millimeter wave sensor 6 and the image captured by the image sensor 3, makes a stationary object determination using any one of various known techniques, and based on changes in the location of the stationary object detected by the millimeter wave sensor 6 as viewed from the own vehicle, detects a relative speed of the own vehicle to the stationary object. The stationary object may be an object forming a lane divider line, or an object corresponding to a landmark described later, such as pole or the like. Various processing performed by the relative speed detector 17 corresponds to a relative speed detection procedure.

The relative speed of the own vehicle to the stationary object, detected by the relative speed detector 17, is equal to an absolute speed of the own vehicle. Assuming that the relative speed of the own vehicle is an actual vehicle speed of the own vehicle, the relative speed is estimated as a reference vehicle speed used to calculate a scale factor. The relative speed detector 17 outputs data Dd representing the reference speed to the scale factor calculator 18.

The scale factor calculator 18 calculates the scale factor of the vehicle speed sensor 5 based on the sensor vehicle speed represented by the data Dc and the reference vehicle speed represented by the data Dd. As described later in detail, the scale factor calculator 18 calculates the scale factor SFc every predetermined time interval. The scale factor calculator 18 time-series processes the scale factors SFc acquired at a plurality of times to calculate a representative value SF of the scale factors. The scale factor calculator 18 outputs data De representing the representative value SF to the ego-motion calculator 12. Scale factor learning means calculating the representative value SF of the scale factors. Various processing performed by the scale factor calculator 18 corresponds to a calculation procedure.

The landmark detector 11 detects landmarks based on the data Db and outputs landmark location information Df relating to locations of the detected landmarks to the map generator 14. The landmarks may include traffic signs, signboards, poles, such as telephone poles and street lights. The ego-motion calculator 12 calculates a vehicle speed of the own vehicle based on the signal Sa from the vehicle speed sensor 5 and the data De from the SF learner 10.

The ego-motion calculator 12 calculates an ego-motion that is a parameter representing a posture of the own vehicle based on the detected vehicle speed and the data Db representing the image captured by the image sensor 3. The SfM technique is used to calculated the ego-motion. In calculation of the ego-motion, the ego-motion calculator 12 is capable of correction based on the GPS information Da, that is, GPS correction. The ego-motion calculator 12 outputs data Dg representing the calculated ego-motion to the map generator 14.

The lane-of-travel recognizer 13 recognizes a lane of travel of the own vehicle that is a lane in which the own vehicle is traveling based on the data Db and acquires roadway parameters and lane divider line information presenting lane divider lines demarcating the lane of travel. The roadway parameters include information representing a lane shape, such as a width of the lane and a curvature of the lane (or the roadway), and information representing a driving state of the own vehicle, such as an offset which is a distance between the lateral center of the lane and the location of the own vehicle, and a yaw angle which is an angle between a tangential direction of the lane (or the roadway) and a travel direction of the own vehicle. The lane-of-travel recognizer 13 outputs data Dh representing the roadway parameters to the vehicle controller 4 and data Di representing the lane divider line information to the map generator 14.

The map generator 14 generates map information based on the data Df from the landmark detector 11 and the data Dg from the ego-motion calculator 12, and the data Di from the lane-of-travel recognizer 13. In the following, the map information generated by the map generator 14 is referred to as a probe map. Data Dj representing the probe map generated by the map generator 14 is uploaded to the server 2 as probe data and output to the localizer 15.

The localizer 15 performs localization for estimating a current location of the own vehicle. The localizer 15 downloads data Dk representing the integrated map from the server 2, and based on the downloaded data Dk, the data Dj representing the probe map, and the data Db representing the image captured by the image sensor 3, performs localization on the integrated map. The localizer 15 may perform localization without using the data Dj representing the probe map.

If localization is successful, the localizer 15 calculates roadway parameters based on the map information and outputs data DI representing the roadway parameters based on the map information to the vehicle controller 4. Based on the data Dh from the lane-of-travel recognizer 13 and the data DI from the localizer 15, the vehicle controller 4 performs various processing to control travel of the own vehicle. That is, the vehicle controller 4 performs various processing to control travel of the own vehicle based on the roadway parameters.

Processing performed by the controller 9 will now be described with reference to a flowchart of FIG. 2. The controller 9 performs the processing shown in FIG. 2 every predetermined time interval.

At step S100, the controller 9 acquires a relative speed of the own vehicle to at least one stationary object based on the signal Sb from the millimeter wave sensor 6 and estimates a reference vehicle speed. If a relative speed of the own vehicle to one stationary object is acquired, the controller 9 estimates the relative speed of the own vehicle to the one stationary object as a reference vehicle speed. If relative speeds of the own vehicle to two or more stationary objects are acquired, the controller 9 estimates an average over the relative speeds of the own vehicle to the two or more stationary objects as a reference vehicle speed.

At step S200, the controller 9 acquires a sensor vehicle speed based on the signal Sa from the vehicle speed sensor 5. At step S300, the controller 9 calculates a scale factor SFc at the current time based on the following equation (2):

SFc=vref/vsen (2)

where vref represents the reference vehicle speed and vsen represents the sensor vehicle speed.

At step S400, the controller 9 time-series processes the scale factors SFc acquired for up to the previous N cycles (N being a positive integer greater than one), thereby calculating a representative value SF of the N scale factors. More specifically, at step S400, the controller 9 calculates an average over the N scale factors SFc as the representative value SF.

At step S500, the controller 9 calculates an ego-motion using the SfM technique. The vehicle speed of the own vehicle calculated using the representative value SF and the data Db representing the image captured by the image sensor 3 are used to calculate the ego-motion. At step S600, the controller 9 generates the probe map based on data Dg representing the ego-motion calculated at step S500 and other data set forth above.

At step S700, the controller 9 uploads the probe map generated at step S600 to the server 2. At step S800, the controller 9 performs localization on the integrated map based on data Dk representing the integrated map downloaded from the server 2, data Dj representing the probe map, and the data Db representing the image captured by the image sensor 3. Thereafter, the process flow ends.

The present embodiment can provide the following advantages.

In the present embodiment, the SF learner 10 that learns the scale factor of the vehicle speed sensor 5 includes the sensor reading acquirer 16, the relative speed detector 17, and the scale factor calculator 18. The sensor reading acquirer 16 acquires a detected vehicle speed that is a sensor reading from the vehicle speed sensor 5. The relative speed detector 17 detects a relative speed of the own vehicle to a stationary object based on a result of detection by the millimeter wave sensor 6 and other data set forth above. The scale factor calculator 18 calculates the scale factor based on the relative speed and the detected vehicle speed.

In the above configuration, the relative speed of the own vehicle to the stationary object, detected by the relative speed detector 17, is equal to the absolute speed of the own vehicle. Therefore, assuming that the relative speed of the own vehicle is a true vehicle speed of the own vehicle, the scale factor calculator 18 can calculate a value of the scale factor based on a relationship between the true value and the detected value of the vehicle speed as what it should be. The above configuration enables accurately learning the scale factor of the vehicle speed sensor 5. In the present embodiment, this can prevent the scale factor from significantly deviating from what it should be, thus preventing occurrence of errors in the SfM technique. This can maintain good accuracy of the localization and the map generation.

Techniques for leaning the scale factor of the vehicle speed sensor 5, other than the technique set forth above, may include following two techniques. A first technique to learn the scale factor of the vehicle speed sensor 5 includes comparing a GPS movement amount and the integral of the vehicle speed on a long straight path. The GPS movement amount is an amount of movement of the own vehicle calculated based on the GPS information Da. The integral of the vehicle speed is an integrated value of a detected speed from the vehicle speed vehicle speed sensor 5. Assumption that the GPS movement amount is a true amount of movement can provide a correct value of the scale factor.

A second technique to learn the scale factor of the vehicle speed sensor 5 includes comparing a distance between landmarks on the map information and a detected distance between the landmarks on a long straight path. Assumption that the distance between landmarks on the map information is a true value of the distance between the landmarks can provide a correct value of the scale factor. In the following description, the first technique is referred to as a first comparative example, and the second technique is referred to as a second comparative example.

In the first and second comparative examples, a certain travel distance is required to acquire a correct value of the scale factor, which may give rise an issue that a time to learn the scale factor will be increased. In the first comparative example, since there are GPS errors in location information, a travel distance on which the GPS errors have a negligible impact on is required. For example, a travel distance is required such that a ratio of the error to the amount of movement is 1%. In the second comparative example, in a road segment having not many landmarks, a relatively long travel distance will be required to detect landmark spacings.

In contrast, with the technique of the present embodiment, without depending on a travel distance of the own vehicle, a time to learn the scale factor can be determined based on a time to make a stationary object determination, a time to detect a relative speed of the own vehicle to a stationary object, and others. Such a configuration of the present embodiment, as compared to the first and second comparative examples, can reduce the time to learn the scale factor and thus enables a result of learning to be reflected earlier. Further, in the above configuration of the present embodiment, the relative speed of the own vehicle is detected using the millimeter wave sensor 6, enabling further increasing the accuracy of detecting the relative speed and thus further increasing the accuracy of learning the scale factor.

Second Embodiment

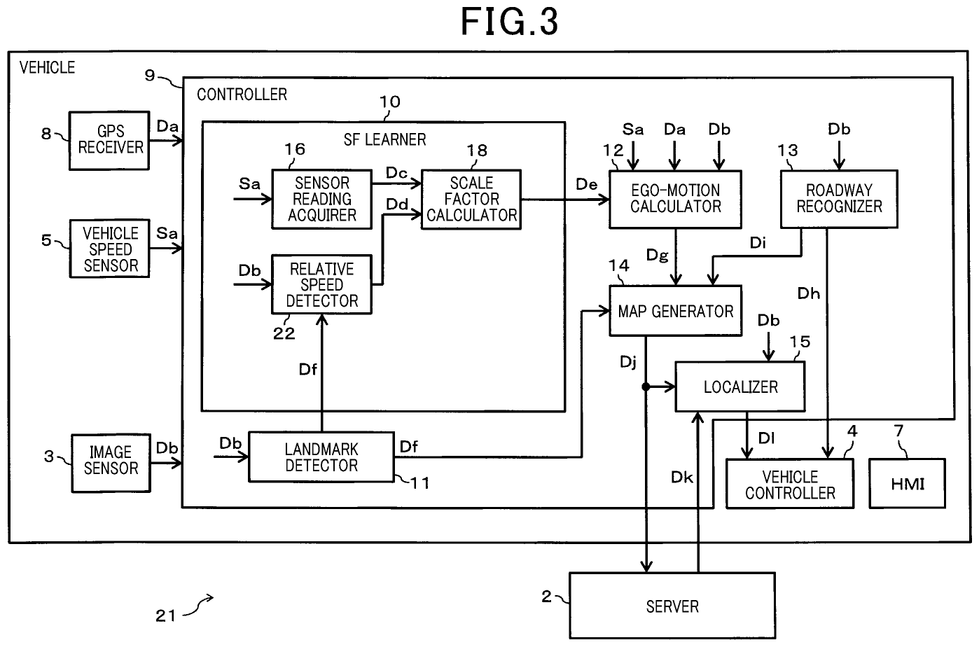

A second embodiment will now be described with reference to FIG. 3.

As shown in FIG. 3, a map system 21 of the second embodiment is different from the map system 1 of the first embodiment in that the millimeter wave sensor 6 is removed and the relative speed detector 17 is replaced with a relative speed detector 22. The relative speed detector 22 detects a relative speed of the own vehicle to a stationary object based on changes in size of the stationary object. The image sensor 3 corresponds to an object detector adapted to detect objects around the own vehicle.

The relative speed detector 22 receives data Db representing captured images from the image sensor 3 and landmark location information Df from the landmark detector 11. Based on the data Db and Df, the relative speed detector 22 detects a relative speed of the own vehicle to a stationary object, such as a traffic sign, a road marking or the like, whose size can be uniquely determined from a result of image recognition.

The relative speed of the own vehicle can be detected as follows. Given at least one stationary object detected, the relative speed detector 22 acquires a size of the at least one stationary object on the image. The relative speed detector 22 acquires changes in size of the at least one stationary object over the images captured at two or more successive times and determines a physical size of the at least one stationary object from the map information. Based on the size on the image and the physical size of the at least one stationary object, the relative speed detector 22 calculates a distance between the own vehicle and the at least one stationary object. The relative speed detector 22 calculates a time to collision based on a magnification ratio between these sizes. The relative speed detector 22 calculates a relative speed of the own vehicle to the at least one stationary object based on the time to collision and the distance between the own vehicle and the at least one stationary object.

The integrated map downloaded from the server 2 includes physical sizes of stationary objects, such as traffic signs, road markings and the like, each of which can be an object whose relative speed to the own vehicle can be acquired. Such information relating to the physical sizes of the stationary objects may be acquired as follows. It should be noted that a traffic sign or the like does not have a definite size corresponding to the type of the sign, but may be varied to some extent. It is thus impossible to have a full understanding of the actual size of the sign on the server 2.

In the present embodiment, the server 2 checks actual sizes of traffic signs or the like based on the probe data uploaded from each vehicle, and generates and updates information about the sizes. The relative speed detector 22 of the own vehicle can detect a relative speed by referring to the physical size of at least one of the traffic signs or the like included in the integrated map generated in this way. Processing performed by the relative speed detector 22 corresponds to a relative speed detection procedure.

As described above, the relative speed detector 22 of the present embodiment can detect a relative speed of the own vehicle to a stationary object based on changes in size of the stationary object in the captured images from the image sensor 3. Therefore, the technique of the present embodiment, similarly to that of the first embodiment, enables accurately learning the scale factor of the vehicle speed sensor 5, which provides similar advantages to those of the first embodiment. Moreover, in the present embodiment, the scale factor can be learned without using an additional sensor, such as the millimeter wave sensor 6, which can simplify the vehicle-side configuration of the system.

Third Embodiment

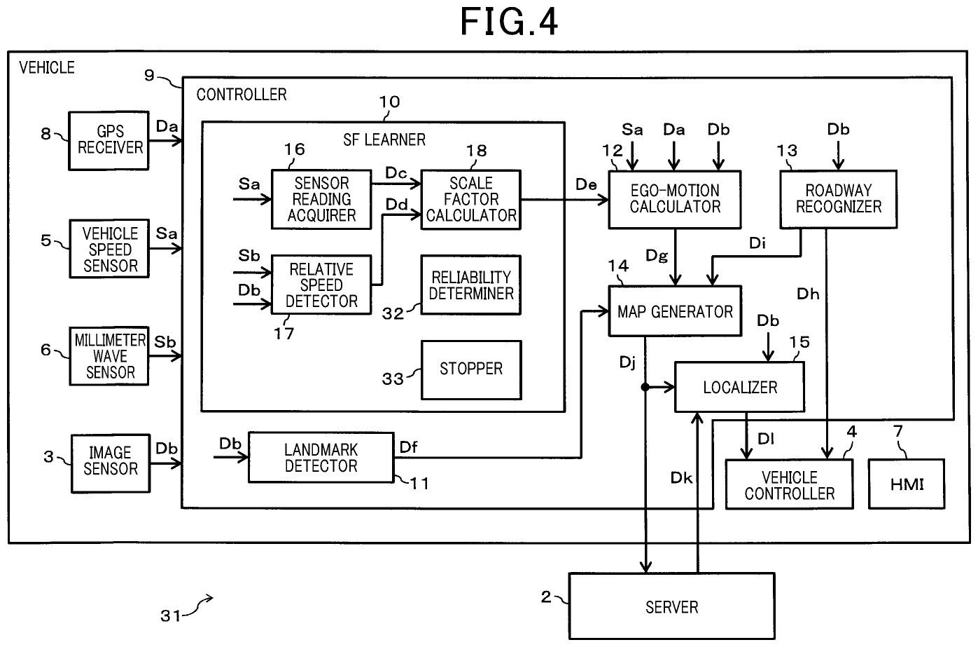

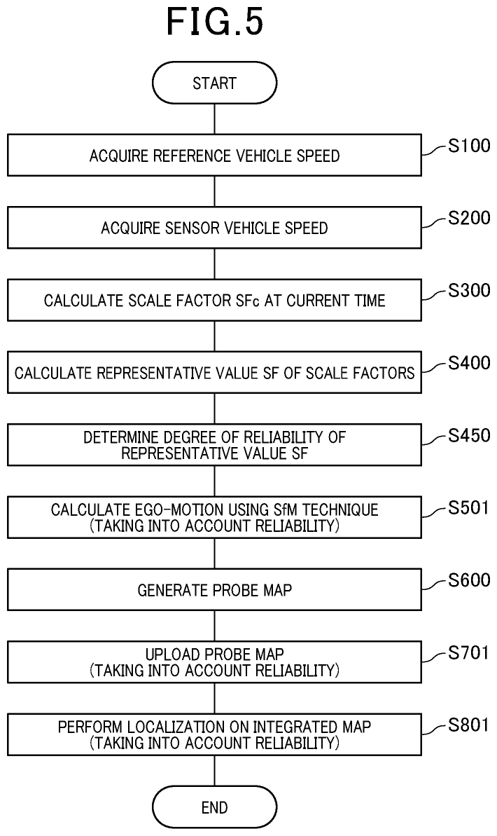

A third embodiment will now be described with reference to FIGS. 4 and 5.

As shown in FIG. 4, a map system 31 of the third embodiment is different from the map system 1 of the first embodiment in that the SF learner 10 of the controller 9 further includes, as functional blocks, a reliability determiner 32 and a stopper 33. The reliability determiner 32 determines the degree of reliability of a result of calculation by the scale factor calculator 18, that is, the representative value SF of the scale factors calculated by the scale factor calculator 18. The technique used by the reliability determiner 32 will be described later. Processing performed by the reliability determiner 32 corresponds to a reliability determination procedure.

The stopper 33 is configured to, if the reliability determiner 32 determines that the reliability of the representative value SF is relatively low, stop specific processing performed directly or indirectly using the vehicle speed that is acquired using the representative value SF. The specific processing includes uploading of the probe map by the map generator 14 and localization by the localizer 15. Processing performed by the stopper corresponds to a stop procedure.

The reliability determiner 32 may determine the reliability by using any one of the following three techniques or any combination of them.

[1] First Determination Technique

A first determination technique includes determining the degree of reliability of the representative value SF in response to a learning status of the scale factors. If the learning status of the scale factors is sufficient, then the reliability determiner 32 determines that the reliability of the representative value SF is relatively high. If the learning status of the scale factors is insufficient, the reliability determiner 32 determines that the reliability of the representative value SF is relatively low.

For example, if the number of scale factors SFc acquired at consecutive times is less than a required number of scale factors to calculate their representative value SF, it is determined that the learning status of the scale factors is insufficient. In an alternative embodiment, if a variance between N scale factors SFc that was used to calculate the representative value SF is greater than a predetermined threshold, then it may be determined that the learning status of the scale factors is insufficient.

[2] Second Determination Technique

As the vehicle speed sensor 5 is configured as a wheel speed sensor, the scale factor of the vehicle speed sensor 5 may vary with a wheel diameter. Thus, a tire replacement may cause a significant change in actual scale factor, which may lead to a deviation between the representative value SF and the actual scale factor. In the second determination technique, the reliability determiner 32 determines whether or not a tire replacement has been made, and based on a result of determination, determines the degree of reliability of the representative value SF.

If no tire replacement has been made, the reliability determiner 32 determines that the reliability of the representative value SF is relatively high. If a tire replacement has been made, the reliability determiner 32 determines that the reliability of the representative value SF is relatively low. Whether or not a tire replacement has been made can be determined based on a displacement between foci of expansion (FOE) before and after a turn on of an ignition switch.

To determine whether or not a tire replacement has been made based on such a FOE displacement, it is needed to determine whether or not the FOE displacement was caused by the tire replacement or by a change in superimposed load. To this end, a desirable configuration may be provided such that the presence or absence of occupants, the presence or absence of superimposed load, the number of occupants, changes in superimposed load can be checked based on images captured by an image sensor, such as an inward-looking camera, for capturing images of the interior of the own vehicle, and a result of detection by a load sensor installed at each seat of the own vehicle for detecting the presence or absence of an occupant of the seat. This configuration enables readily determining whether the FOE displacement was caused by the tire replacement or by a change in superimposed load.

[3] Third Determination Technique

The scale factor of the vehicle speed sensor 5 that is a wheel speed sensor may vary with changes in tire wear condition and in tire air pressure. The third determination technique determines the degree of reliability based on changes in tire wear condition and in tire air pressure. If it is determined that both a rate of change in tire wear condition and a rate of change in tire air pressure is equal to or less than a predetermined threshold, it is determined that the reliability of the representative value SF is relatively high. If at least one of a rate of change in tire wear condition and a rate of change in tire air pressure is greater than the predetermined threshold, it is determined that the reliability of the representative value SF is relatively low. Changes in tire wear condition and in tire air pressure can be detected by a tire mounted sensor or the like.

An example of processing performed by the controller 9 of the present embodiment will now be described with reference to a flowchart of FIG. 5. Processing of the present embodiment shown in FIG. 5 is different from processing of the first embodiment shown in FIG. 2 in that step S450 is added and steps S500, S700 and S800 are replaced with steps S501, S701 and S801.

After execution of step S400, the process flow proceeds to step S450. At step S450, the controller 9 determines the degree of reliability of the representative value SF using any one of the above-described techniques or any combination of them. After execution of step S450, the process flow proceeds to step S501. At step S501, as in step S500, the controller 9 calculates an ego-motion. At step S501, when making a correction to the ego-motion based on the GPS information Da, the controller 9 changes the magnitude of such GPS correction in response to the degree of reliability determined at step S450.

More specifically, the controller 9 sets a binary weighting factor for GPS correction such that the magnitude of GPS correction is set low if the degree of reliability of the representative value SF is relatively high and the magnitude of GPS correction is set high if the degree of reliability of the representative value SF is relatively low. In an alternative embodiment, at step S450, the controller 9 may be configured to set a multilevel weighting factor for GPS correction such that the magnitude of GPS correction is decreased as the degree of reliability of the representative value SF increases and the magnitude of GPS correction is increased as the degree of reliability of the representative value SF decreases.

At step S701, the controller 9 uploads the probe map taking into account the reliability of the representative value SF determined at step S450. That is, at step S701, if it is determined that the reliability of the representative value SF is relatively high, the controller 9 uploads the probe map as in step S700. At step S701, if it is determined that the reliability of the representative value SF is relatively low, the controller 9 stops uploading the probe map as in step S700.

That is, at step S701, the controller 9 uploads the probe map having road sections with the reliability of the representative value SF determined to be relatively low removed. In an alternative embodiment, instead of removing from probe map road sections with the reliability of the representative value SF determined to be relatively low, the controller 9 may upload the probe map including road sections assigned with flag information indicating that the reliability of the representative value SF is relatively low. In such an embodiment, the server 2 may determine proper handling of the uploaded probe map.

At step S801, the controller 9 performs localization taking into account the reliability of the representative value SF determined at step S450. That is, at step S801, if it is determined that the reliability of the representative value SF is relatively high, the controller 9 performs localization as in step S800. At step S801, if it is determined that the reliability of the representative value SF is relatively low, the controller 9 stops performing localization or performs localization on the integrated map based on the data Db representing images captured by the image sensor 3 without using data Dj representing the probe map.

In an alternative embodiment, even if it is determined that the reliability of the representative value SF is relatively low, the controller 9 may perform localization on the integrated map using data Dj representing the probe map. In such an embodiment, preferably, a decision threshold used to determine whether or not the localization was successful may be increased to above a normal value.

As described above, in the present embodiment, the reliability determiner 32 is configured to determine the degree of reliability of the representative value SF of the scale factors. The stopper 33 is configured to, if the reliability determiner 32 determines that the reliability of the representative value SF is relatively low, stop the probe map upload and the localization.

The representative value SF of the scale factors learned by the SF learner 10 is not necessarily close to what it should be. For example, the representative value SF of the scale factors may deviate from what it should be when a tire replacement has been made. A value of vehicle speed calculated using the representative value SF deviating from what it should be will be different from the actual value of vehicle speed. Use of such a value of vehicle speed deviating from the actual value of vehicle speed may reduce the accuracy of ego-motion calculation and thus reduce the accuracy of map generation and localization.

In contrast, in the present embodiment, for example, when a tire replacement has been made, it is determined that the reliability of the representative value SF is low, whereby the probe map upload and the localization will be stopped. This configuration can prevent the probe map with low reliability that may cause errors in the integrated map from being uploaded to the server 2, which can maintain good accuracy of the integrated map. Further, this configuration can prevent the localization from being performed using a value of vehicle speed deviating from the actual value of vehicle speed, which can maintain good accuracy of the localization.

In addition, in the present embodiment, if it is determined that the reliability of the representative value SF is low, the magnitude of GPS correction in the ego-motion calculation is increased. This configuration can prevent lowering of the accuracy of the ego-motion calculation caused by use of a value of vehicle speed deviating from the actual value of vehicle speed. Therefore, even if it is determined that the reliability of the representative value SF is relatively low, localization on the integrated map is allowed to be performed using the data Dj representing the probe map. Further, increasing a decision threshold used to determine whether or not the localization was successful to above a normal value can maintain better accuracy of the localization.

Fourth Embodiment

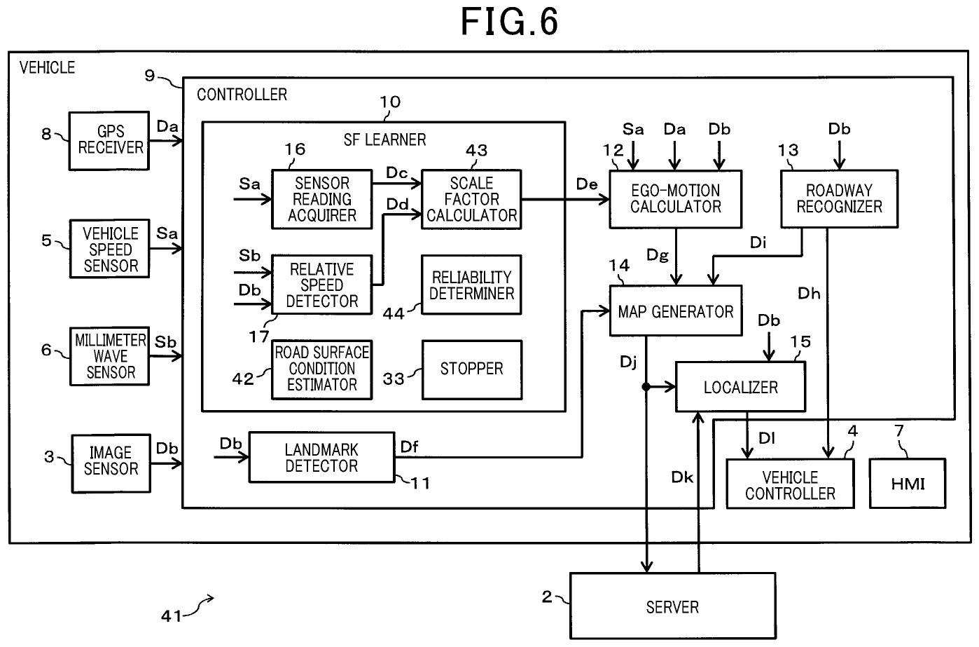

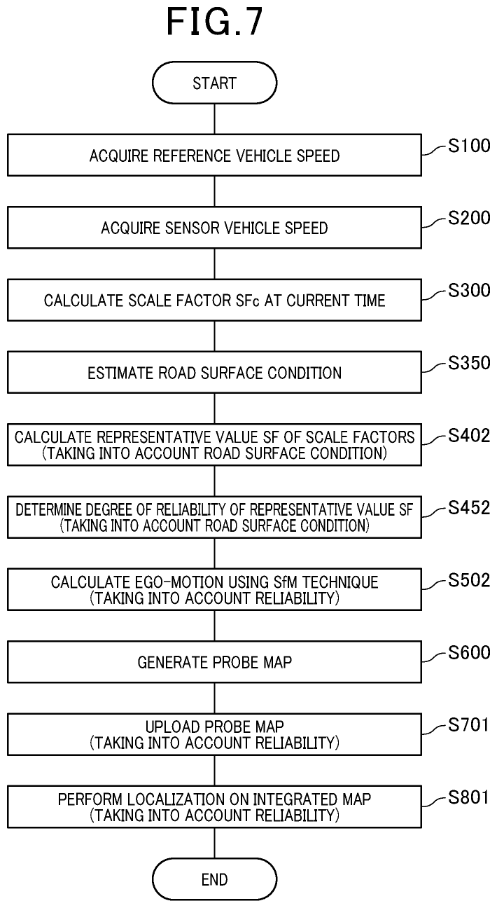

A fourth embodiment will now be described with reference to FIGS. 6 and 7.

As shown in FIG. 6, a map system 41 of the fourth embodiment is different from the map system 31 of the third embodiment in that the SF learner 10 of the controller 9 further includes, as a functional block, a road surface condition estimator 42, and the scale factor calculator 18 and the reliability determiner 32 are replaced with a scale factor calculator 43 and a reliability determiner 44.

The road surface condition estimator 42 estimates a condition of a road surface on which the own vehicle is traveling. Each process performed by the road surface condition estimator 42 corresponds to a road surface condition estimation procedure. The road surface condition estimator 42 may estimate a road surface condition by using any one of the following three techniques or any combination of them.

[1] First Estimation Technique

A first estimation technique estimates a road surface condition by means of image processing utilizing deep learning. The first estimation technique applies image processing to the data Db representing images captured by the image sensor 3 to estimate a road surface condition.

[2] Second Estimation Technique

A second estimation technique estimates a road surface condition by means of communications with the server 2. The second estimation technique estimates a road surface condition based on an outside temperature detected by a temperature sensor mounted to the own vehicle and weather information. Therefore, the second estimation technique can estimate whether or not the current road surface condition is a rough road surface, such as an icy road surface, a snowy road surface, a wet road surface or the like. The second estimation technique may estimate a road surface condition taking into account additional rain drop detection information on a windshield surface detected by a rain sensor. The rain sensor may be any one of conventional rain sensors to be mounted on an inner surface the windshield and opposed to the windshield.

[3] Third Estimation Technique

A third estimation technique estimates a road surface condition utilizing communications with the server 2. The road surface condition estimator 42 estimates that a road surface condition at a location where the scale factor SFc at the current time abruptly changes is a rough road surface, and uploads information about the rough road surface to the server 2. The server 2 integrates information about the rough road surface uploaded from respective vehicles, and distributes the integrated information about the rough road surface to the respective vehicles. Use of such integrated information about the rough road surface downloaded from the server 2 enables the road surface condition estimator 42 mounted to each vehicle to accurately estimate a location of the rough road surface.

The scale factor calculator 43 of the present embodiment calculates the representative value SF of the scale factors taking into account a result of estimation of a road surface condition by the road surface condition estimator 42. In such a configuration, the representative value SF of the scale factors is calculated in response to each of a plurality of road surface conditions. For example, the representative value SF of scale factors corresponding to a dry road surface is calculated as a representative value SF0, the representative value SF of scale factors corresponding to a snowy road surface is calculated as a representative value SF1, and the representative value SF of scale factors corresponding to a dirt road surface is calculated as a representative value SF2. In the following, if there is no need to differentiate between these representative values calculated for different road surface conditions, these representative values will be merely referred to as a representative value SF. Each process performed by the scale factor calculator 43 corresponds to a calculation procedure.

Alternatively or additionally to the technique of the reliability determiner 32 for determining the degree of reliability of the representative value SF, the reliability determiner 44 of the present embodiment determines the degree of reliability of the representative value SF of scale factors based on a result of estimation of a road surface condition by the road surface condition estimator 42. On the rough road surface set forth above that is slippery, the scale factors are not stable, which is likely to cause a deviation of the representative value SF of scale factors from the actual scale factor.

The reliability determiner 44 of the present embodiment is configured to, if the road surface condition estimated by the road surface condition estimator 42 is a road surface condition other than the rough road surface, determines that the degree of reliability of the representative value SF of scale factors is relatively high, and if the road surface condition estimated by the road surface condition estimator 42 is the rough road surface, determines that the degree of reliability of the representative value SF of scale factors is relatively low. Each process performed by the reliability determiner 44 corresponds to a reliability determination procedure.

An example of processing performed by the controller 9 of the present embodiment will now be described with reference to a flowchart of FIG. 7. Processing of the present embodiment shown in FIG. 7 is different from processing of the third embodiment shown in FIG. 5 in that step S350 is added and steps S400, S450 and S501 are replaced with steps S402, S452 and S502.

After execution of step S300, the process flow proceeds to step S350. At step S350, a road surface condition is estimated using the technique set forth above.

After execution of step S350, the process flow proceeds to step S402. At step S402, the controller 9 calculates a representative value SF of scale factors corresponding to the current road surface condition estimated at step S350, in a similar manner as in step S400. After execution of step S402, the process flow proceeds to step S452. At step S452, using the above-described technique or techniques, the controller 9 determines the degree of reliability of the representative value SF corresponding to the current road surface condition.

After execution of step S452, the process flow proceeds to step S502. At step S502, as in step S501, the controller 9 calculates an ego-motion. At step S502, a vehicle speed of the own vehicle detected using the representative value SF of scale factors corresponding to the current road surface condition is used. For example, if the current road surface condition estimated at step S350 is a dry road, the representative value SF0 is used. If the current road surface condition estimated at step S350 is a dirt road, the representative value SF2.

As described above, in the present embodiment, the road surface condition estimator 42 configured to estimate a road surface condition is added. The scale factor calculator 43 calculates a representative value SF of scale factors corresponding to a respective one of a plurality of road surface conditions taking into account a result of road surface condition estimation by the road surface condition estimator 42. An ego-motion is calculated using a vehicle speed of the own vehicle detected with use of the representative value SF of scale factors corresponding to the current road surface condition. The actual scale factor may change as the road surface condition changes. In the present embodiment, the representative value SF of scale factors used to calculate a vehicle speed is changed with a change in the road surface condition. That is, the representative value SF of scale factors is used responsive to the road surface condition, which enables maintaining high accuracy of ego-motion calculation even if the road surface condition changes.

The representative value SF of scale factors leaned by the SF learner 10 is likely to deviate from what it should be when the own vehicle is traveling on a rough road. In the present embodiment, the reliability determiner 44 determines the degree of reliability of the representative value SF of scale factors based on a result of road surface condition estimation by the road surface condition estimator 42. When the own vehicle is traveling on a rough road, the reliability determiner 44 determines that the degree of reliability of the representative value SF of scale factors is low and then upload of the probe map and the localization will be stopped. This configuration prevents a probe map with low reliability that may cause errors in the integrated map from being uploaded to the server 2, which enables maintaining good accuracy of the integrated map. Further, this can prevent the localization from being performed using a vehicle speed different from the actual vehicle speed, which enables maintaining good accuracy.

Modifications

Specific embodiments of the present disclosure have so far been described. However, the present disclosure should not be construed as being limited to the foregoing embodiments, but may be modified in various modes.

In each of the map systems 1, 21, 31, 41, functional blocks may be distributed over a plurality of hardware components of the map system. For example, some of the functional blocks included in the controller 9 on the vehicle side may be moved to a controller (not shown) of the server 2. In such an embodiment, scale factors of the vehicle speed sensor may be learned via communications of various data between the controllers in the system.

While only certain features of the invention have been illustrated and described herein, many modifications and changes will occur to those skilled in the art. It is, therefore, to be understood that the appended claims are intended to cover all such modifications and changes as falling within the true spirit of the invention.

What is claimed is:

1. An apparatus for learning a scale factor used to calculate a true value of a speed of a vehicle from a detected speed that is a sensor reading from a vehicle speed sensor, comprising:
a sensor reading acquirer configured to acquire the detected speed from the vehicle speed sensor;
a relative speed detector configured to detect a relative speed of the vehicle to a stationary object based on a result of detection by an object detector that detects an object around the vehicle; and
a scale factor calculator configured to calculate the scale factor based on the relative speed and the detected speed.

2. The apparatus according to claim 1, wherein
the object detector includes a radar device that transmits radar waves in a forward and travel direction of the vehicle and receives reflected waves from the object around the vehicle, and
the relative speed detector is configured to, based on a change in location of the stationary object detected by the radar device as viewed from the vehicle, detect a relative speed of the vehicle to the stationary object.

3. The apparatus according to claim 1, wherein
the object detector includes an imager that captures an image in a forward and travel direction of the vehicle, and
the relative speed detector is configured to, based on a change in size of the stationary object in the image captured by the imager as viewed from the vehicle, detect a relative speed of the vehicle to the stationary object.

4. The apparatus according to claim 1, further comprising:
a reliability determiner configured to determine a degree of reliability of a result of calculation by the scale factor calculator; and
a stopper configured to, if the reliability determiner determines that the degree of reliability is relatively low, stop specific processing which would otherwise be performed directly or indirectly using the vehicle speed calculated with use of the scale factor.

5. The apparatus according to claim 4, wherein
the reliability determiner is configured to determine whether or not a tire replacement has been made in the vehicle, and based on a result of determination as to whether or not a tire replacement has been made in the vehicle, determine the degree of reliability of the result of calculation by the scale factor calculator.

6. The apparatus according to claim 4, further comprising a road surface condition estimator configured to estimate a road surface condition that is a condition of a road surface on which the vehicle is traveling,
wherein the reliability determiner is configured to, based on a result of estimation of the road surface condition by the road surface condition estimator, determine the degree of reliability of the result of calculation by the scale factor calculator.

7. The apparatus according to claim 1, further comprising a road surface condition estimator configured to estimate a road surface condition that is a condition of a road surface on which the vehicle is traveling,
wherein the scale factor calculator is configured to calculate the scale factor taking into account a result of estimation of the road surface condition by the road surface condition estimator.

8. A method for learning a scale factor used to calculate a true value of a speed of a vehicle from a detected speed that is a sensor reading from a vehicle speed sensor, the method comprising:
acquiring the detected speed from the vehicle speed sensor;
detecting a relative speed of the vehicle to a stationary object based on a result of detection by an object detector that detects an object around the vehicle; and
calculating the scale factor based on the relative speed and the detected speed.

9. A non-transitory, tangible computer-readable storage medium on which computer readable instructions of a program are stored, the instructions, when executed by a processor, causing the processor to perform a method for learning a scale factor used to calculate a true value of a speed of a vehicle from a detected speed that is a sensor reading from a vehicle speed sensor, the method comprising:
acquiring the detected speed from the vehicle speed sensor;
detecting a relative speed of the vehicle to a stationary object based on a result of detection by an object detector that detects an object around the vehicle; and
calculating the scale factor based on the relative speed and the detected speed.
